(19) United States
(12) Patent Application Publication
(10) Pub. No.: US 2019/0176020 A1
(43) Pub. Date: Jun. 13, 2019

(54) BALL-STRIKING ASSIST METHOD, BALL-STRIKING ASSIST SYSTEM, AND PORTABLE ELECTRONIC DEVICE

(71) Applicant: Shenzhen Image Technology Co., Ltd., Shenzhen (CN)

(72) Inventor: CHUAN-BING LI, Shenzhen (CN)

(21) Appl. No.: 16/276,937

(22) Filed: Feb. 15, 2019

Related U.S. Application Data
(63) Continuation-in-part of application No. PCT/CN2016/096783, filed on Aug. 25, 2016.

(51) Int. Cl. A63D 15/00; A63B 71/06; G06T 7/73; G06T 19/00

(52) U.S. Cl. CPC A63D 15/006; A63B 71/0622; A63B 2071/0647; G06T 19/006; A63B 2071/063; G06T 7/73

(57) ABSTRACT

A striking assist method for a ball game such as snooker on a bounded table, a striking assist system, and a portable electronic device are described. The striking assist method includes acquiring pictures or videos of a snooker table in play, analyzing positions of balls in the pictures and the videos to get positions, calculating a striking path of at least one ball according to the position, and providing a striking suggestion to a user according to the striking path. The striking suggestion can be graphically or audibly provided to the user through the portable electronic device.

### FIELD

The present disclosure relates to ball striking in bounded table game.

### BACKGROUND

Billiards is a sport and an entertainment for others. There are international competitions for billiards and for related table games such as snooker and American pool. For billiard players, it is important to constantly improve their striking skills.

Thus, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a schematic view of a billiard table and billiard balls set on the billiard table.

FIG. 2 is a block diagram of a ball-striking assist system of a first embodiment of the present disclosure.

FIG. 3 shows an image acquired by an acquisition module corresponding to the billiard table and the billiard balls shown in FIG. 1.

FIG. 4 is a schematic diagram of striking path of billiard balls.

FIG. 5 is a block diagram of a ball-striking assist system of a second embodiment of the present disclosure.

FIG. 6 shows selection of a target ball in the second embodiment of the present disclosure.

FIG. 7 is a schematic diagram showing position and manner of placement of a cue stick in the second embodiment of the present disclosure.

FIG. 8 is a schematic diagram of path of ball after striking.

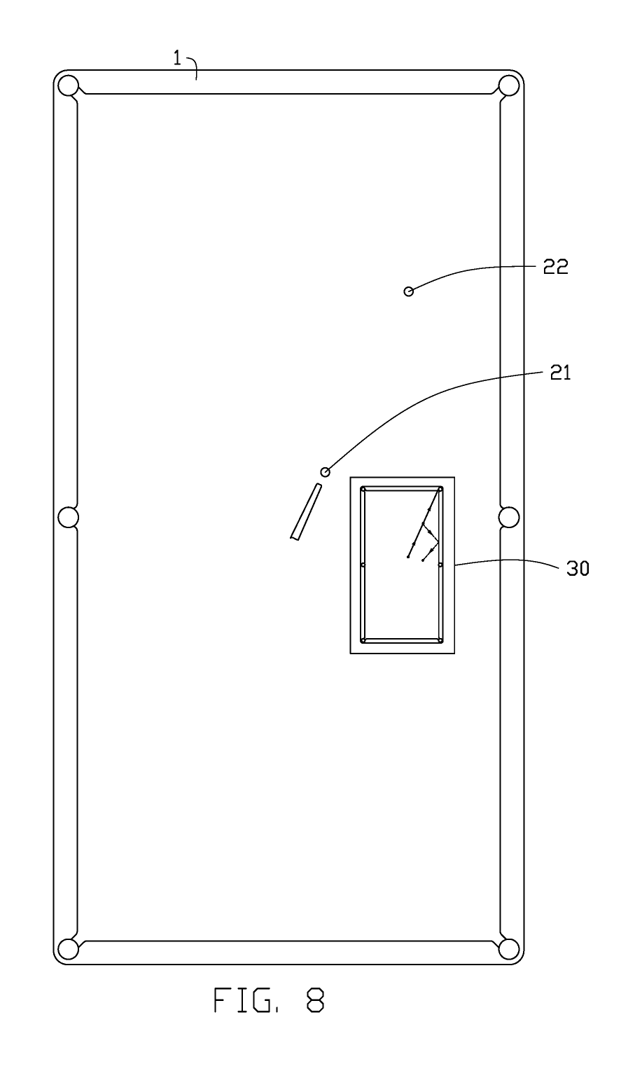

FIG. 9 is a block diagram of a portable electronic device of a third embodiment of the present disclosure.

FIG. 10 is a block diagram of an image acquisition module of the third embodiment of the present disclosure.

FIG. 11 is a flowchart of a ball-striking assist method implemented by the ball-striking assist system shown in FIG. 2.

FIG. 12 is a flowchart of a ball-striking assist method implemented by the ball-striking assist system shown in FIG. 5.

FIG. 13 is a block diagram of a ball-striking assist system including a storage medium.

### DETAILED DESCRIPTION

The present disclosure, including the accompanying drawings, is illustrated by way of examples and not by way of limitation. In general, the word “module,” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series, and the like.

A first embodiment is described below.

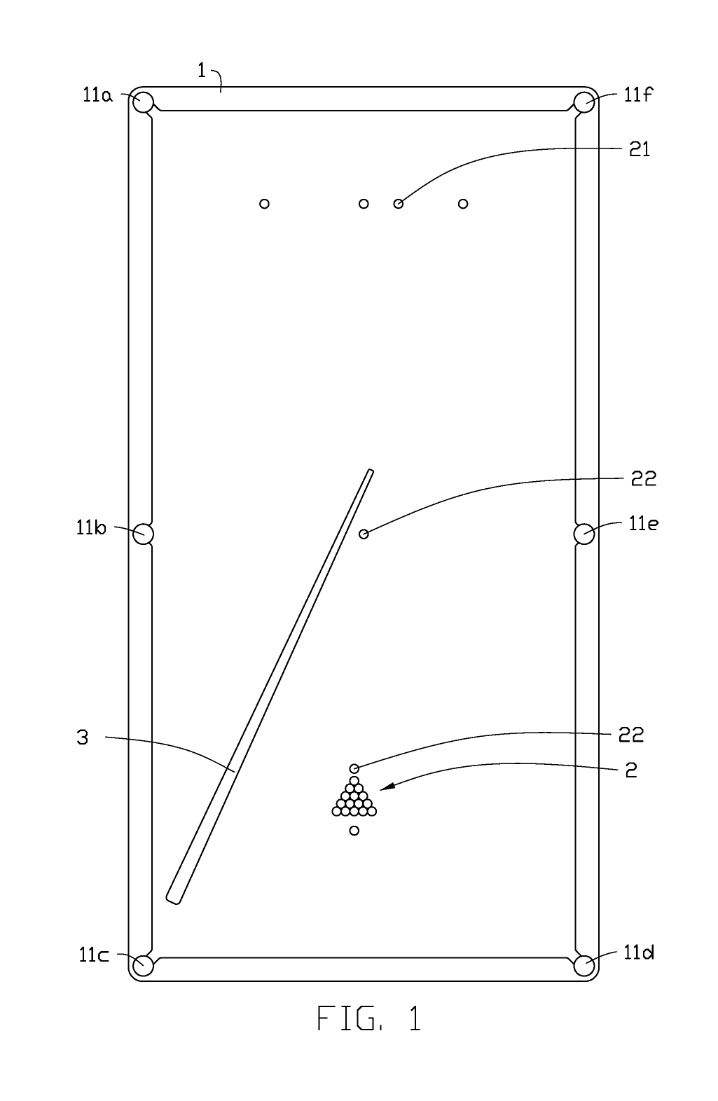

Referring to FIG. 1, a plurality of billiard balls 2 are positioned on a billiard table 1. The billiard balls 2 include at least one cue ball 21 and a plurality of target balls 22. The present disclosure takes the game of snooker as an example.

Alternatively, in other embodiments of the present disclosure, other snooker-type ball games may be used, such as British proportional billiards, American billiards, French billiards, or Chinese billiards, the disclosure is not limited.

The billiard table 1 has a rectangular shape, and includes four holes 11 at four corners of the billiard table 1 and two holes 11 at centers of the long sides. The six holes 11 are 11a, 11b, 11c, 11d, 11e, and 11f(see FIG. 1).

A total of twenty-two balls are positioned on the billiard table 1, one of which is a white cue ball 21, and the other twenty-one are target balls 22. The twenty-one target balls 22 includes fifteen red balls and six colored balls. The six colored balls are the yellow, green, brown, blue, pink, and black balls. A cue stick 3 is used to hit the cue ball 21 to strike the target balls 22 into the holes 11 to get scores.

Before breaking, which is the initial state, fifteen red balls are gathered together into an equilateral triangle placed in a red ball area. The red ball at the top of the triangle is located on the center line of the short sides of the billiard table 1. The pink ball is adjacent to the red ball at the top of the triangle, but not touching the red ball at the top of the triangle. The yellow ball is placed in the right side of a D zone. The green ball is placed in the left side of the D zone. The brown ball is placed at the center of the breaking line. The blue ball is placed at a center spot. The black ball is shielded by the triangle.

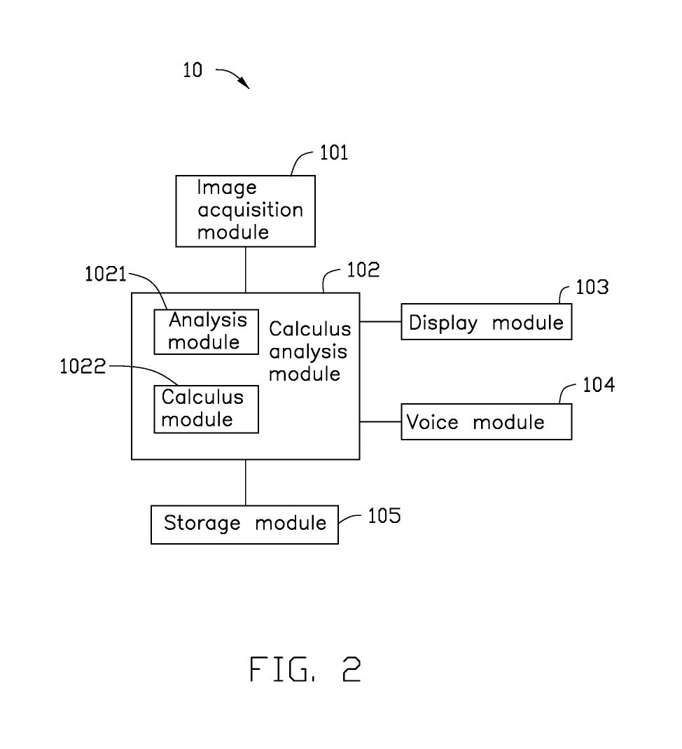

Referring to FIG. 2, the ball-striking assist system 10 is implemented by a software installed in a portable electronic device. The portable electronic device can be a smart phone, a flat computer, or a smart wearable device. The smart wearable device can be a virtual reality helmet, an augmented reality helmet, or a smart watch. The smart wearable device also can be a virtual reality headset, an augmented reality headset (such as augmented reality glasses), and the like. In the first embodiment of the present disclosure, the portable electronic device is a smart phone. The first embodiment uses a smart phone as the portable electronic device.

Specifically, the ball-striking assist system 10 includes an image acquisition module 101, a calculus analysis module 102, a display module 103, a voice module 104, and a storage module 105.

The image acquisition module 101 is configured to acquire image information including a positional relationship between the billiard balls 2 and the billiard table 1. The image information of the billiard table 1 includes positions of holes 11. The positional relationship between the billiard balls 2 and the billiard table 1 includes coordinate positions of the twenty two billiard balls 2 on the billiard table 1, and also includes the colors of the billiard balls 2 on the billiard table 1. In the first embodiment, the image acquisition module 101 can be an imaging device. The image information includes video information that can be single or multiple pictures or continuous multiple frames.

Preferably, the image acquisition module 101 acquires at least two pictures at different angles, in order to more accurately determine coordinate positions of the billiard balls 2, and in particular to determine coordinate positions of the cue ball 21 and the target balls 22.

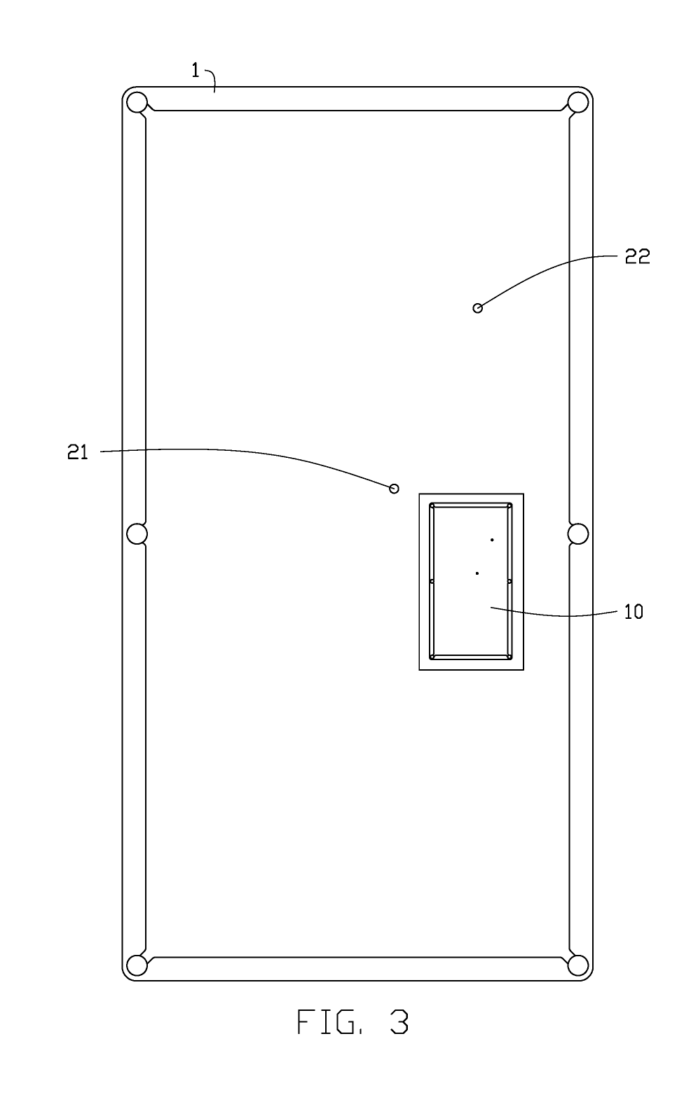

Referring to FIG. 2 and FIG. 3, FIG. 3 includes a first image corresponding to the billiards table 1 and the billiard balls 2 shown in FIG. 1. The first image is displayed on the display module 103 of the ball-striking assist system 10. The relative positional relationships between the billiard table 1, the billiard balls 2, and the holes 11 are recorded in the first image. The billiard balls 2 include the cue ball 21 and target balls 22.

The calculus analysis module 102 includes an analysis module 1021 and a calculus module 1022. The calculus analysis module 102 can be implemented by a processor of the portable electronic device.

Referring to FIG. 2, the analysis module 1021 is configured to analyze the coordinate positions and colors of each billiard ball 2 on the billiard table 1, and positions of holes 11 in the image information acquired by the image acquisition module 101. Analysis results are extracted and transmitted to the calculation module 1022 by the analysis module 1021. The coordinate positions can be acquired from a two-dimensional coordinate established by the edge of the billiard table 1, for example, the long side and the short side of the billiard table 1 connected at the hole 11d can be treated as the X-axis and the Y-axis of the two-dimensional coordinate.

The calculus module 1022 matches the analysis results with an analysis model to predict the best striking path. In an offensive situation, the striking path includes at least a path between the cue ball 21, the target balls 22, and the holes 11. In the defensive situation, the striking path includes at least a path between the cue ball 21 and the target balls 22.

The analysis model is at least one virtual model pre-established and stored in the storage module 105. The virtual model may be two-dimensional or three-dimensional corresponding to the software depicting the billiard table 1 and the billiard balls 2. Due to different types of billiards playing rules and different scoring methods, the virtual model is established according to the type of billiards. Different types of billiards have different virtual models, such as American billiards and Chinese billiards.

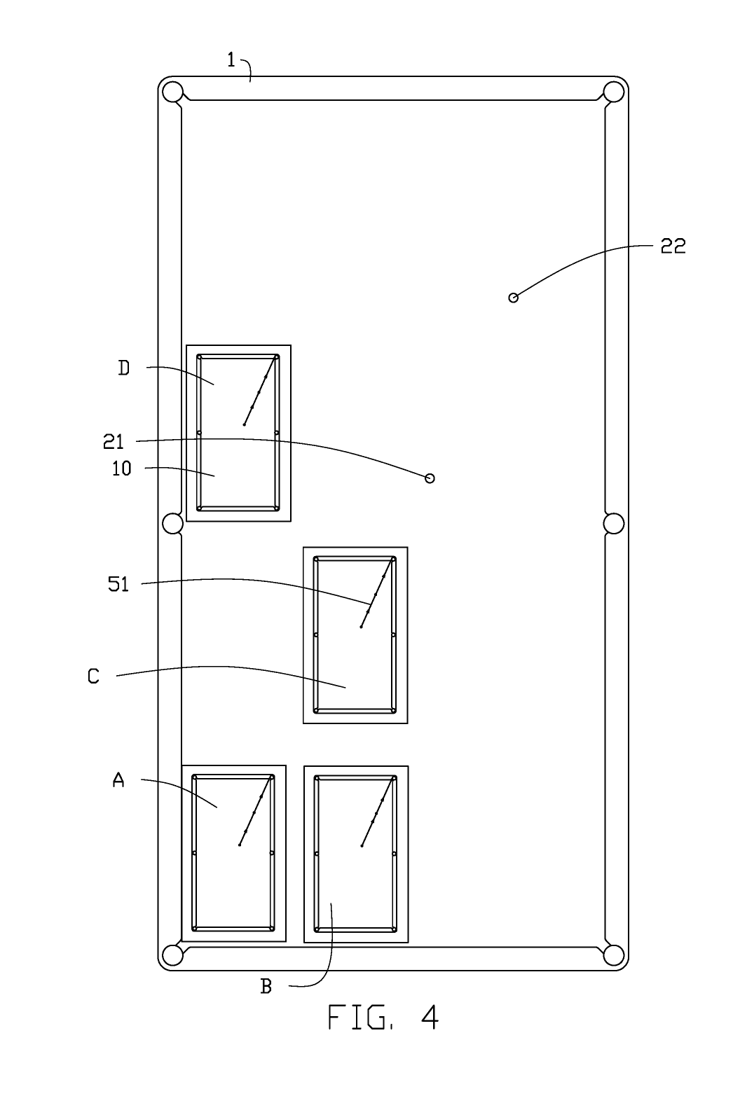

Referring to FIG. 4, a second image including a striking path is shown in FIG. 4. The second image also can be displayed on the display module 103 of the ball-striking assist system 10. The calculus module 1022 inputs information into the virtual model, such as the coordinate positions and colors of each billiard ball 2 on the billiard table 1 in the analysis results, and further calculates the best striking path according to a calculation rule in the virtual model. Different virtual models can correspond to different calculation rules.

The calculus module 1022 can further calculate the striking angle, the striking strength, the striking position, the striking manner, the shooting speed, and the like according to calculation rules corresponding to the virtual model. The calculus module 1022 can display the above-mentioned information such as the striking angle and the striking strength in a graphical or numerical manner in the virtual model. The calculus module 1022 can further control the virtual model attached with the above-mentioned information to be displayed on the display module 103 through the second image.

Preferably, according to the calculation rule in the virtual model, the calculus module 1022 can further calculate a movement path and a stop position of the cue ball after striking a target ball, and control the information of the movement path and the stop position to be displayed on the display module 103 through the second image, to facilitate the user viewing and understanding more striking information.

Since the virtual model includes information of coordinate positions and colors of each billiard ball 2 on the billiard table 1, information of the striking path, the striking angle, the striking strength, the striking position, the shooting speed, and the striking manner, and the information of the movement path and the stop position of the cue ball after striking the target ball, the second image can display one, or two, or multiple, or all of the coordinate positions and colors of each billiard ball 2 on the billiard table 1. Information of the striking path, the striking angle, the striking strength, the striking position, the shooting speed, and the striking manner, and the information of the movement path and the stop position of the cue ball after striking the target ball can also be given.

The calculation module 1022 transmits foregoing calculation results to the display module 103 for displaying in virtual model, and outputs to the voice module 104 for voice description. Therefore, the display module 103 and the voice module 104 can give the user a striking suggestion according to foregoing calculation results. In making suggestions as to certain shots, the calculation results can be provided to the user by the display module 103 and the voice module 104.

The calculation results may include information of the striking path, the striking angle, the striking strength, the striking position, the shooting speed, and the striking manner, and the information of the movement path and the stop position of the cue ball after striking the target ball. Therefore, the striking suggestion includes the information of the striking path, the striking angle, the striking strength, the striking position, the shooting speed, and the striking manner, and the information of the movement path and the stop position of the cue ball after striking the target ball.

The striking path in the calculation result is preferably superimposed on the image information acquired by the image acquisition module 101 (such as the first image) and then transmitted to the display module 103 for display, or may be superimposed and displayed on the second image including the virtual model. Additionally, the striking angle, the striking strength, the striking position, the shooting speed, the striking manner, and the like may be displayed in the second image, or may be played by the voice module 104 in a voice manner.

Specifically, referring to FIG. 4, the virtual model displays a desktop image consistent with the current billiard table 1 through the display module 103. The desktop image shows all billiard balls 2 on the billiard table 1 and their positions. The desktop image is preferably a model map of the billiard table obtained by modeling the image information acquired by the image acquisition module 101 (such as the second image described above). In other embodiments, the desktop image may be an image acquired by the image acquisition module 101 (such as the first image described above).

In the virtual model rendered in the desktop image, the striking path may be an indicator line that is directly superimposed and displayed in the desktop image. The indicator line is connected between the cue ball, the target ball, and the target hole. In the offensive situation, the indicator line is a predicted path indicator line between the cue ball, the target ball, and the target hole. In the defensive situation, the indicator line is a predicted path indicator line between the cue ball, the target ball, and a predicted defensive position. The indicator line may further include an arrow from the cue ball to the target ball, and an arrow between the target ball to the target hole, or between the target ball and the predicted defensive position. The predicted path is an expected moving path of the target ball after being struck according to the indicator line, such as a predicted moving path of a target ball entering a target hole, or a predicted moving path of the target ball moving to a predicted defensive position.

The striking path may further include labels of the target ball and the target hole. The labels of the target ball and the target hole may be flashing patterns further positioned on the target ball or on the target hole in the image, which is convenient for the user to watch. In other embodiments, the labels of the target ball and the target hole may be text information directly displayed on the display module 103, or may be played as voice information.

Referring to FIG. 4, the user can place the portable electronic device carrying or displaying the desktop image on the billiard table 1. The length and width of the display module 303 of the portable electronic device can be respectively parallel to the length and width of the physical billiard table. The length and width of the billiard table in the displayed desktop image of the display module 303 of the portable electronic device can be respectively parallel to the length and width of the physical billiard table. The desktop image may include the cue ball, the target ball, and the indicator line of the striking path. The user can refer to the indicator line of the striking path in the desktop image to place the physical cue stick to hit the billiard balls. Specifically, in one embodiment, the user can place the portable electronic device carrying the display module 103 on the extension line of the striking path of the target ball, the portable electronic device being adjacent to the cue ball. As shown in FIG. 4, the portable electronic device is placed at position A or position C (preferably placed at the position A of the billiard table edge). When the user refers to the indicator line of the striking path displayed by the display module 103 to place the physical cue stick, the direction or positioning angle of the physical cue stick in the user's hand is the best striking direction (also called the best striking angle). Therefore, the success rate of the user's striking can be improved.

In another embodiment, if there is another billiard ball at the position A or the position C, the portable electronic device having the display module 103 can also be placed in position B or position D. It is required to ensure that length and width of the billiard table displayed by the display module 103 of the portable electronic device can be respectively parallel to the length and width of the physical billiard table. At this time, the user can first determine the direction in which the physical cue stick is placed corresponding to a virtual cue stick image on the portable electronic device, and then align the physical cue stick to the position corresponding to the cue ball.

Compared with the prior art, the ball-striking assist method, the ball-striking assist system, and the portable electronic device of the present disclosure can calculate the striking path and give the striking suggestion by analyzing the position of at least one billiard ball in pictures or videos, and provide the striking suggestion to the user by the portable electronic device to help the billiard player raise the level of striking.

A second embodiment is described below.

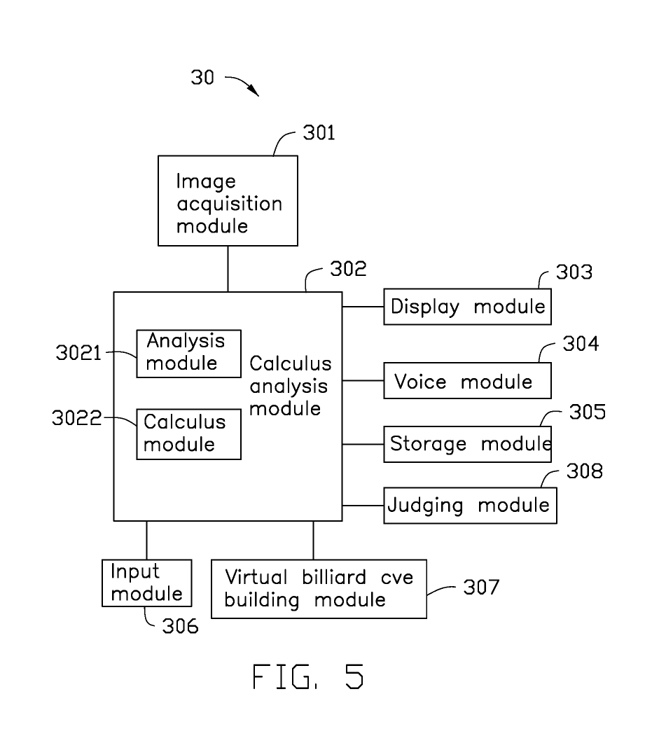

Referring to FIG. 5, a ball-striking assist system 30 of the second embodiment is shown. The ball-striking assist system 30 is substantially the same as the ball-striking assist system 10 of the first embodiment, that is, the description of the ball-striking assist system 10 in the first embodiment can be basically used for the ball-striking assist system 30 of the second embodiment. The main difference between the ball-striking assist system 30 and the ball-striking assist system 10 of the first embodiment is that in addition to an image acquisition module 301, a calculus analysis module 302, a display module 303, a voice module 304, and a storage module 305, the ball-striking assist system 30 further includes an input module 306, a virtual cue stick building module 307, and a judging module 308. The function of the image acquisition module 301, the calculation analysis module 302, the display module 303, the voice module 304, and the storage module 305, are basically the same as the functions of the image acquisition module 101, the calculation analysis module 102, the display module 103, the voice module 104, and the storage module 105 of the first embodiment. The details already explained in the first embodiment will not be repeated here.

Specifically, the input module 306 is configured to receive input information from the user, thereby facilitating the user to select which target ball to strike. The input module 306 may be a voice input module (such as a microphone) or a touch input module (such as a touch screen). In an embodiment, the input module can be a touch screen disposed on the display module 303.

The input module 306 analyzes the received input information, and displays the striking path of the target ball selected by the user according to the input information. Specifically, the display module 303 can display a desktop image, which is the first picture, consistent with the layout of the current billiard table. The desktop image includes all billiard balls on the current billiard table and their location information. The desktop image is preferably a model map of a billiard table obtained by modeling the image information acquired by the image acquisition module 301. In other embodiments, the desktop image may also be an actual image, which is the second image, acquired by the image acquisition module 301. The user can select a billiard ball in the desktop image as a target ball through the input module.

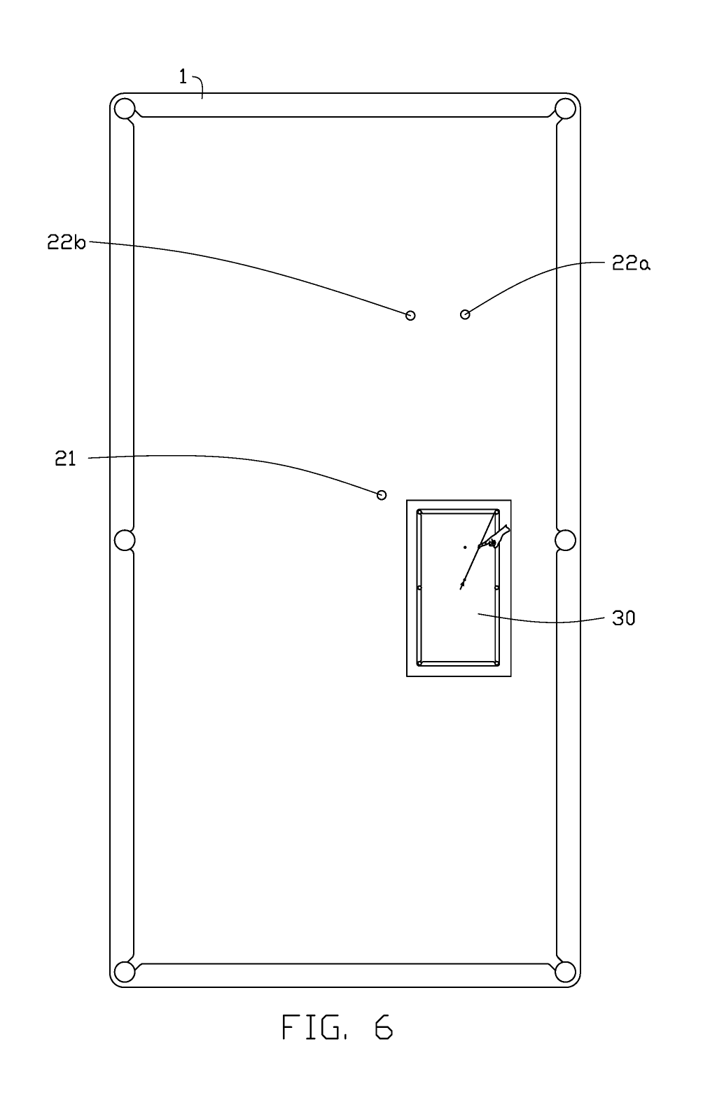

FIG. 6 shows selection of a target ball in the second embodiment of the present disclosure. The user can select a target ball 22 to be struck according to preference. As shown in FIG. 6, when the user selects the target ball 22a, the calculus module 3022 calculates the striking path (such as the best striking path) of the target ball 22a, and displays the information of the striking path of the target ball 22a, to give the user a striking suggestion. Specifically, the display module 303 can be a touch display module. The user can select a certain billiard ball as the target ball 22 on the desktop image by clicking (such as clicking or double clicking), circle drawing, and the like.

The virtual cue stick building module 307 is configured to create a virtual cue stick image with the same width as the physical cue stick, and the virtual cue stick image is located on the striking path. Therefore, the user can easily strike the billiard ball with reference to the angle and width of the cue in the virtual cue stick image.

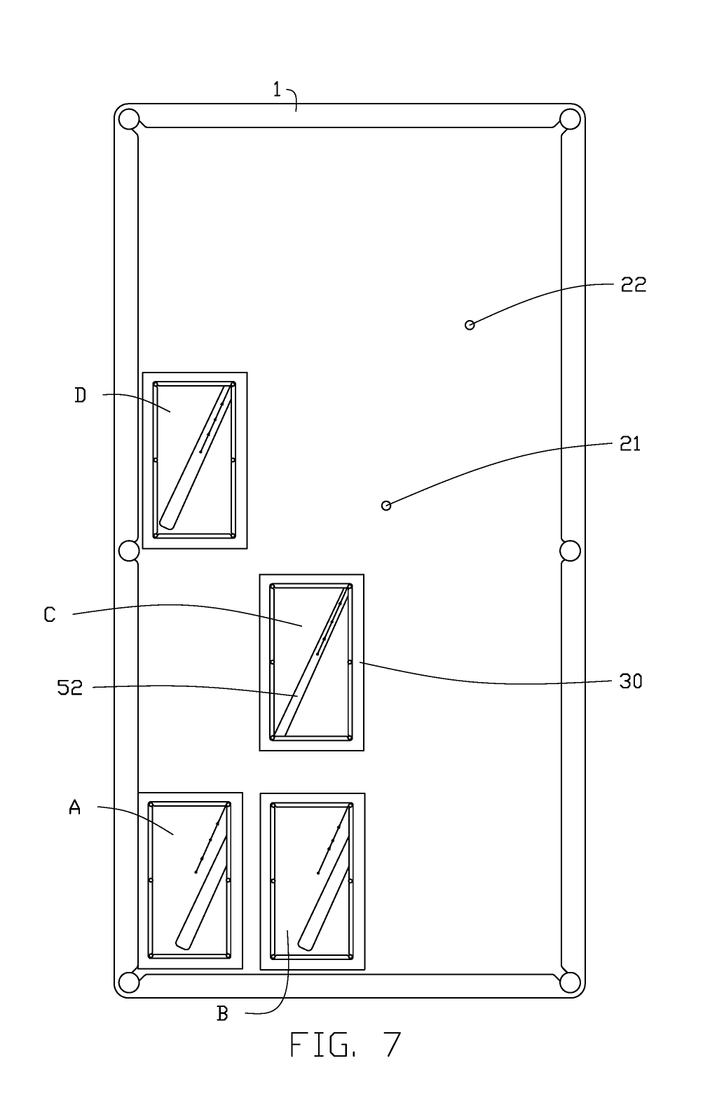

Referring to FIG. 7, the position and manner of placing a virtual cue stick in the second embodiment is shown. The portable electronic device carrying the display module 303 is placed on the billiard table. The length and width of the display module 303 of the portable electronic device can be respectively parallel to the length and width of the billiard table. The user can strike the billiard ball with reference to the angle and width of the cue stick in the virtual cue stick image. Specifically, the user can place the portable electronic device along the edge of the billiard table. The virtual cue stick image may be a partial cue image, and the width of the partial cue image is consistent with the projected width of the physical cue stick. Since the projected width of the physical cue stick (the diameter thereof) is gradually increased from the head (striking end) to the tail, the width of the virtual cue stick image displayed on the display module 303 is also gradually increased from the head to the tail. Therefore, it is convenient for the user to align the physical cue stick with the virtual cue stick image. In addition, the user can adjust portion of the virtual cue stick displayed in the virtual cue stick image through the input module. For example, the virtual cue stick image originally displaying the middle part of the virtual cue stick can be adjusted to display the front or the rear part of the virtual cue stick by the user according to actual needs. Specifically, when the input module is a touch screen disposed on the display module, the user can slide the virtual cue stick image displayed on the screen to adjust the display position of the virtual cue stick. Therefore, it is convenient to align the physical cue stick with the virtual cue stick.

In one embodiment, the user can place the portable electronic device carrying the display module 303 on the extension line of the striking path of the target ball, the portable electronic device being adjacent to the cue ball. As shown in FIG. 7, the portable electronic device is placed at position A or position C (preferably placed at the position A of the billiard table edge). At this time, the virtual cue stick image displayed by the display module 303 includes only a part of the virtual cue stick. When the user places the physical cue stick corresponding to the width and angle of the virtual cue stick in the image, the direction or positioning angle of the physical cue stick in the user's hand is the best striking direction (also called the best striking angle). Therefore, the success rate of the user's striking can be improved.

In another embodiment, if there is another billiard ball at the position A or the position C, the portable electronic device having the display module 303 can be placed at position B or position D. It is required to ensure that length and width of the billiard table displayed by the display module 303 can be respectively parallel to the length and width of the physical billiard table. At this time, the user can first determine the direction of the physical cue stick according to the virtual cue stick image on the portable electronic device, and then align the physical cue stick in the position corresponding to the cue ball.

Alternatively, in another embodiment, the ball-striking assist system 30 further includes a judging module 308. The judging module 308 is configured to obtain an actual placement direction (or an actual angle or an actual placement angle) of the physical cue stick 3 in the user's hand, and compare the actual placement direction with the direction of the striking path calculated by the calculation module, to determine whether the actual placement direction of the physical cue stick 3 in the user's hand is correct, and to provide the judgment result to the user. Specifically, the judging module 308 can obtain a picture or video of the actual placement direction of the physical cue stick 3, and analyze the actual placement direction according to the picture or video. The picture or video of the actual placement direction of the physical cue stick 3 can be obtained by the image acquisition module 301, and the image acquisition module 301 can be a front camera of the portable electronic device. During application, as shown in FIG. 4, the portable electronic device can be placed at the position A or position B, so that the image acquisition module 301 can obtain the picture of the physical cue stick 3, and the picture is analyzed to get the actual placement direction of the physical cue stick 3.

Specifically, when the actual placement direction of the physical cue stick 3 in the user's hand is substantially the same as the direction of the striking path, the difference between the two being within a predetermined range, the judging module 308 controls the display module 303 to display “the actual placement direction of the physical billiard 3 is correct” to the user. Obviously, the judging module 308 also can control the voice module 304 to say “the actual placement direction of the physical billiard 3 is correct” to the user. When the actual placement direction of the physical cue stick 3 in the user's hand is different from the direction of the striking path, the difference between the two being over the predetermined range, the judging module 308 controls the display module 303 to display “the actual placement direction of the physical billiard 3 is incorrect” to the user. Obviously, the judging module 308 can control the voice module 304 to warn “the actual placement direction of the physical billiard 3 is incorrect” to the user. Furthermore, when the actual placement direction of the physical billiard 3 is incorrect, the judging module may provide an adjustment suggestion according to the judgment result.

Compared with the first embodiment, the ball-striking assist system of the second embodiment further includes the input module 306, the virtual cue stick building module 307, and the judging module 308. The input module 306 can let the user choose the target ball by himself. The virtual cue stick building module 307 can let the display module 303 display the virtual cue stick image, and the user can place the physical cue stick according to the virtual cue stick image. The judging module 308 is configured to judge whether the physical cue stick is placed in correct direction. Therefore, the user experience is improved, and the success rate and level of striking are improved.

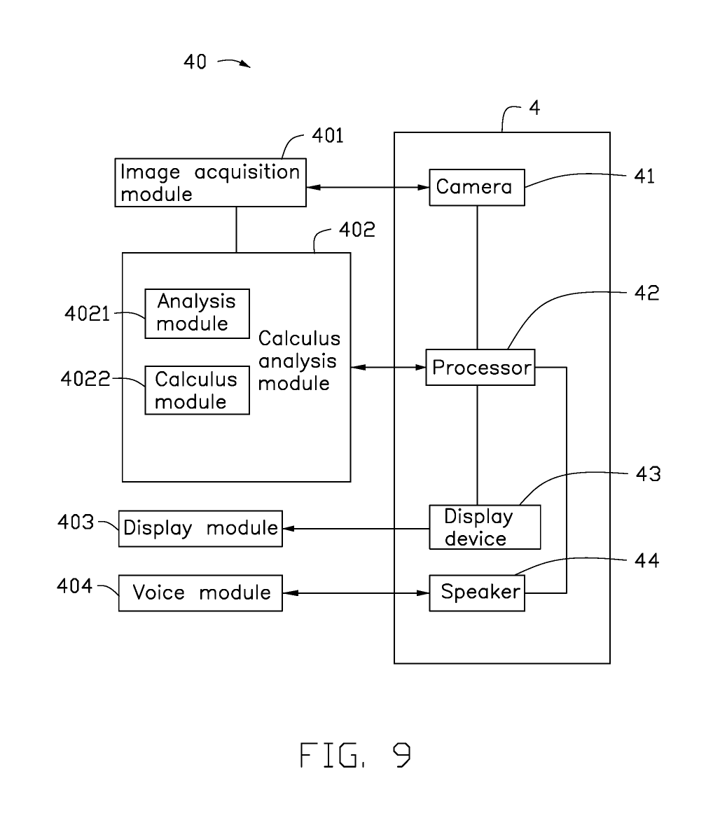

FIG. 9 shows a block diagram of a portable electronic device in a third embodiment.

In the third embodiment, the portable electronic device is an augmented reality device 4. A ball-striking assist system 40 is operated in the augmented reality device 4. The augmented reality device 4 may be an augmented reality glasses, an augmented reality helmet, or the like. The augmented reality device 4 includes a camera 41, a processor 42, a display device 43, and a speaker 44.

The ball-striking assist system 40 includes an image acquisition module 401, a calculus analysis module 402, a display module 403, and a voice module 404. The image acquisition module 401 acquires pictures or videos through the camera 41. The calculus analysis module 402 implements data processing through the processor 42. The display module 403 displays images through the display device 43. The voice module 404 is implemented by the speaker 44. The display device 43 may be a projection display device, projecting an image onto the retina of a human eye, or onto a lens of an augmented reality glasses or helmet.

Specifically, the image acquisition module 401 is configured to acquire pictures or videos of the billiard table in play.

In one embodiment, the camera 41 of the image acquisition module 401 may be a panoramic imaging device for taking a panoramic picture of the billiard table and billiard balls on the billiard table, so that the calculus analysis module 402 can accurately analyze colors and positions of the billiard balls on the billiard table. In another embodiment, the camera 41 of the image acquisition module 401 can acquire two angles of pictures or videos of the billiard table, such as a first picture or video of a first camera angle, and a second picture or video of a second camera angle. Therefore, the calculus analysis module 402 can accurately analyze colors and positions of the billiard balls on the billiard table by the two angle of pictures or videos. Preferably, the image acquisition module 401 is a stereoscopic imaging device, and the stereoscopic imaging device is configured to take the two angles of pictures or videos.

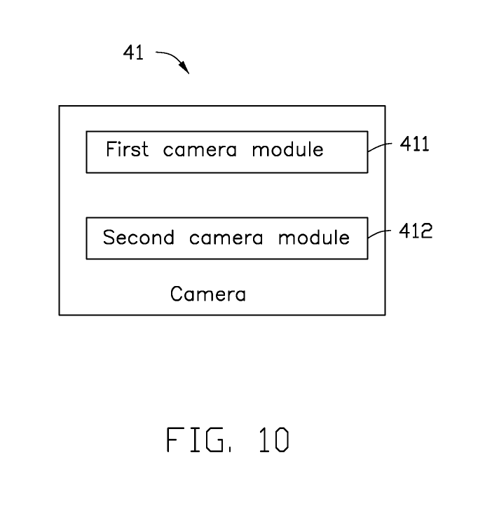

FIG. 10 shows the camera 41 of the image acquisition module 401. The camera 41 includes a first camera module 411 and a second camera module 412. The first camera module 411 and the second camera module 412 are independent of each other, and can take pictures or videos of different angles. The first camera module 411 takes the picture or video of the first camera angle, and the second camera module 412 takes the picture or video of the second camera angle.

In the third embodiment, the first camera module 411 and the second camera module 412 are arranged in different portable electronic devices. The first camera module 411 is arranged in a first portable electronic device, and the second camera module 412 is arranged in a second portable electronic device.

In other embodiments, the first camera module 411 or the second camera module 412 can be independent, and does not need to be arranged in other portable electronic devices.

The calculus analysis module 402 analyzes pictures or videos from the image acquisition module 401, and the positional relationship of at least two billiard balls in the pictures or videos is analyzed. The calculus analysis module 402 calculates a best striking path of the billiard balls according to the positional relationship, and provides a striking suggestion according to the calculation result of the striking path. The calculus analysis module 402 includes an analysis module 4021 and a calculus module 4022 as described in the first embodiment. Therefore, the structure and function of the calculus analysis module 402 will not be repeated here.

The analysis module 4021 is configured to analyze colors and positions of each billiard ball on the billiard table, and to analyze positions of holes. The calculus module 4022 calculates the best striking path according to the analyzing results and an analyzing model.

The display module 403 is configured to display the calculation result of the calculus module 4022 to provide the striking suggestion. The display module 403 can be a liquid crystal display module or an OLED display module, and the display module 403 projects or displays the striking suggestion in an augmented reality manner on the billiard table that the user views. Therefore, the user is capable of easily striking the corresponding billiard ball according to the striking suggestion.

The voice module 404 is configured to play the striking suggestion by voice.

In one embodiment, the calculus analysis module 402 can be set independently of the augmented reality device 4. The processor is able to communicate with the image acquisition module 401, the display module 403, and the voice module 404 by wire or wireless.

The augmented reality device 4 further includes a judging module. The judging module detects the striking motion of the user through the image acquisition module (such as camera), to predict an actual striking path. The actual striking path and the best striking path are compared by the judging module, and the comparing result is provided to the user. The display module 403 displays the best striking path and the actual striking path, so that the user is capable of adjusting the striking motion in real time. Additionally, the best striking path and the actual striking path are superimposed or displayed in an augmented reality manner on the billiard table that the user sees through the augmented reality device 4.

In one embodiment, when the portable electronic device is a smart watch, the calculus analysis module 402 is able to be set independently of the smart watch. The processor is able to communicate with the image acquisition module 401, the display module 403, and the voice module 404 wirelessly. In one embodiment, the image acquisition module 401 is able to be set independently of the smart watch. The image acquisition module 401 may be an independent camera module, or be arranged in other portable electronic device.

In one embodiment, the calculus analysis module 402 is able to receive pictures or videos from different image acquisition modules 401. For example, the images or videos of different orientations provided by the image acquisition module 401 at different camera angles are received by the calculus analysis module 402. Of course, the different image acquisition modules 401 may be arranged in the same portable electronic device, or may be arranged in different portable electronic devices, or even may be set independently.

Comparing with the first embodiment and the second embodiment, the augmented reality device 4 is the portable electronic device of the third embodiment. The augmented reality device 4 is able to be directly worn on the user's head, and may interact with the user by means of voice or motion capture, and display the striking path and other striking suggestions by means of augmented reality. Therefore, it is more convenient for using, and the experience of using is improved.

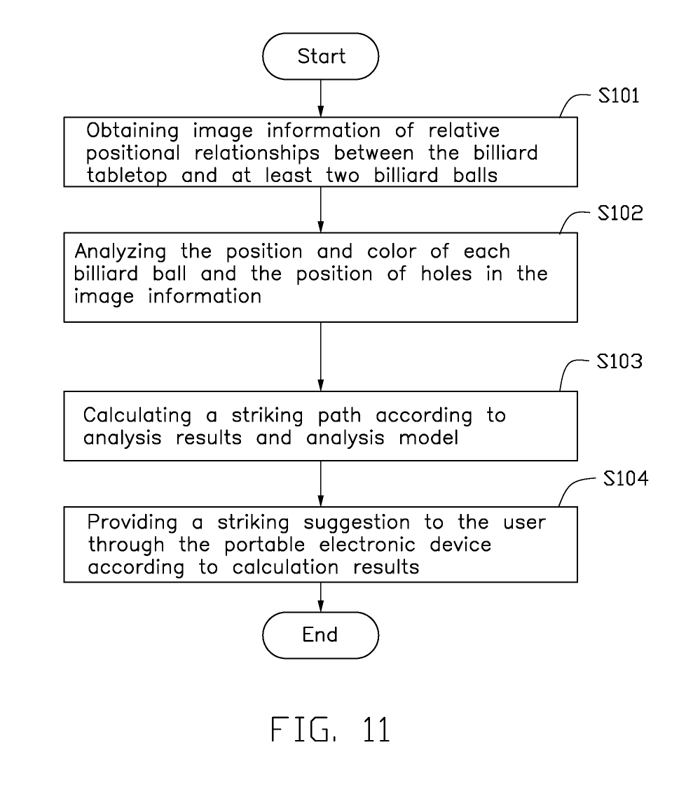

FIG. 11 shows a flowchart of a ball-striking assist method implemented by the ball-striking assist system 10 shown in FIG. 2.

In step S101, obtaining image information of relative positional relationships between the billiard table and at least two billiard balls. The step S101 is performed by the image acquisition module 101.

In step S102, analyzing the position and color of each billiard ball and the position of holes in the image information. The step S102 is performed by the analysis module 1021.

In step S103, calculating a striking path according to analysis results and analysis model. The striking path is the best striking path. The step S103 is performed by the calculus module 1022.

In step S104, providing a striking suggestion to the user through the portable electronic device according to calculation results. The striking suggestion includes at least the striking path. The step S104 is performed by the display module 103 and the voice module 104.

The calculus module 1022 transmit the calculation results to the display module 103 and the voice module 104 for display and voice description. The calculation results may be superimposed on the image information acquired by the image acquisition module 101, and then transmitted to the display module 103 for display. Additionally, striking angle, striking strength, striking position, striking method, striking speed, and the like are able to be played through the voice module 104 in a voice manner.

Furthermore, the calculus module 1022 calculates striking angle, striking strength, striking position, striking method, and striking speed according to calculation rules corresponding to the virtual model, and the movement path and the stop position of the cue ball after striking the target ball are also calculated.

The calculus module 1022 transmits the calculation results to the display module 103 for displaying in the virtual model, and transmits the calculation results to the voice module 104 for voice description. Therefore, the display module 103 and the voice module 104 are able to provide striking suggestion to the user according to the calculation results. In making suggestions as to certain shots, the calculation results can be provided to the user by the display module 103 and the voice module 104.

The calculation results may include the striking path, the striking angel, the striking strength, the striking position, the striking manner, and the striking speed. The calculation results may also include the movement path and the stop position of the cue ball after striking the target ball. Therefore, the striking suggestion provided by the display module includes the striking path, the striking angel, the striking strength, the striking position, the striking manner, and the striking speed. The striking suggestion also includes the movement path and the stop position of the cue ball after striking the target ball.

The striking path in the calculation results is preferably superimposed on the image information (such as the first image) acquired by the image acquisition module 101, and then transmitted to the display module 103 for display. The striking path also may be superimposed on the second image including the virtual model. Additionally, the striking angle, the striking strength, the striking position, the striking manner, and the striking speed are able to be displayed on the second image, or able to be played by the voice module 104 in a voice manner.

Specifically, referring to FIG. 4, the virtual model displays the desktop image consistent with the current billiard table 1 through the display module 103. The desktop image shows all billiard balls on the current billiard table 1 and their positions. The desktop image is preferably a model map of the billiard table obtained by modeling the image information acquired by the image acquisition module 101 (such as the second image described above). In other embodiments, the desktop image may be an image acquired by the image acquisition module 101 (such as the first image described above).

In the virtual model rendered in the desktop image, the striking path 51 may be an indicator line that is directly superimposed and displayed in the desktop image. The indicator line is connected between the cue ball, the target ball and the target hole. In the offensive situation, the indicator line is a predicted path indicator line between the cue ball, the target ball and the target hole. In the defensive situation, the indicator line is a predicted path indicator line between the cue ball, the target ball, and a predicted defensive position. The indicator line may further include an arrow from the cue ball to the target ball, and an arrow between the target ball to the target hole, or between the target ball and the predicted defensive position. The predicted path is an expected moving path of the target ball after being struck according to the indicator line, such as a predicted moving path of a target ball entering a target hole, or a predicted moving path of a target ball moving to a predicted defensive position.

The striking path may further include labels of the target ball and the target hole. The labels of the target ball and the target hole may be flashing patterns on the target ball or on the target hole in the image, which is convenient for the user to watch. In other embodiments, the labels of the target ball and the target hole may be text information directly displayed on the display module 103, or may be played as voice information.

Referring to FIG. 4, the user can place the portable electronic device carrying or displaying the desktop image on the billiard table 1. The length and width of the display module 303 of the portable electronic device can be respectively parallel to the length and width of the billiard table. The length and width of the billiard table in the displayed desktop image of the display module 303 of the portable electronic device can be respectively parallel to the length and width of the physical billiard table. The desktop image may include the cue ball, the target ball, and the indicator line of the striking path. The user can refer to the indicator line of the striking path in the desktop image to place the physical cue stick to hit the billiard balls. Specifically, in one embodiment, the user can place the portable electronic device carrying the display module 103 on the extension line of the striking path of the target ball, the portable electronic device being adjacent to the cue ball. As shown in FIG. 4, the portable electronic device is placed at position A or position C (preferably placed at the position A of the billiard table edge). When the user refers to the indicator line of the striking path displayed by the display module 103 to place the physical cue stick, the direction or positioning angle of the physical cue stick in the user's hand is the best striking direction (also called the best striking angle). Therefore, the success rate of the user's striking can be improved.

In another embodiment, if there is another billiard ball at the position A or the position C, the portable electronic device having the display module 103 can also be placed in position B or position D. It is required to ensure that length and width of the billiard table displayed by the display module 103 of the portable electronic device can be respectively parallel to the length and width of the physical billiard table. At this time, the user can first determine the direction of placing the physical cue stick according to the virtual cue stick image on the portable electronic device, and then align the physical cue stick to the position corresponding to the cue ball.

Compared with the prior art, the ball-striking assist method of the present disclosure can calculate the striking path and give the striking suggestion by analyzing the position of at least one billiard ball in pictures or videos, and provide the striking suggestion to the user through the portable electronic device to help the billiard player raise the level of striking.

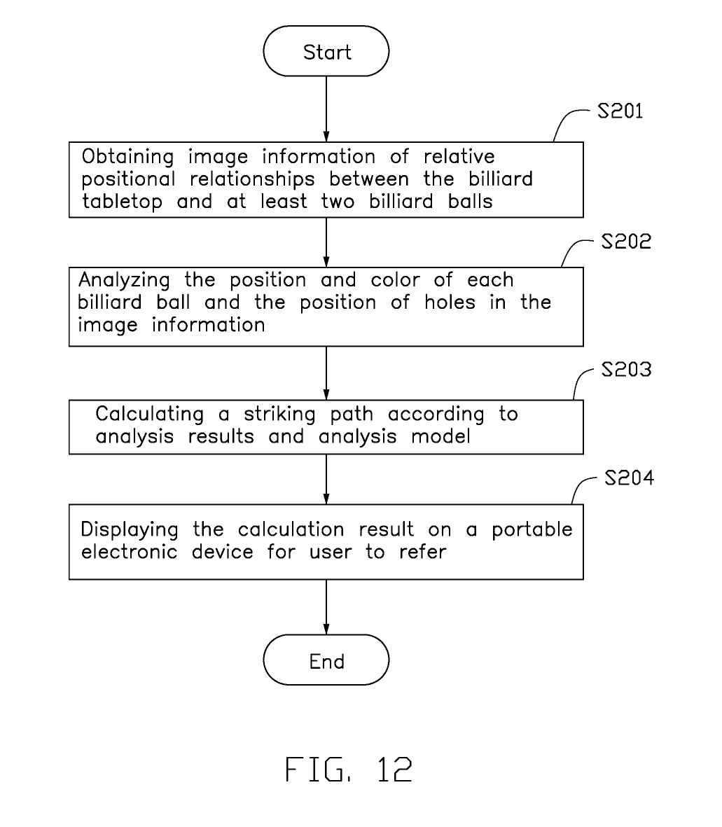

Referring to FIG. 12, it is a flowchart of a ball-striking assist method implemented by the ball-striking assist system 30 of the second embodiment shown in FIG. 5.

In step S201, obtaining image information of relative positional relationships between the billiard table and at least two billiard balls. The step S201 may be performed by the image acquisition module 301.

In step S202, analyzing the position and color of each billiard ball and the position of holes in the image information. The step S202 may be performed by the analysis module 3021.

In step S203, calculating a striking path according to analysis results and analysis model. The striking path is the best striking path. The step S203 may be performed by the calculus module 3022.

Additionally, the input module 306 is configured to receive input information from the user, thereby facilitating the user to select which target ball to strike. The input module 306 may be a voice input module or a touch input module.

Specifically, the input module 306 analyzes the received input information, and displays the striking path of the target ball selected by the user according to the input information. Specifically, the display module 303 can display a desktop image, which is the first picture, consistent with the layout of the current billiard table. The desktop image includes all billiard balls on the current billiard table and their location information. The desktop image is preferably a model map of a billiard table obtained by modeling the image information acquired by the image acquisition module 301. In other embodiments, the desktop image may also be an actual image, which is the second image, acquired by the image acquisition module 301. The user can select a billiard ball in the desktop image as a target ball through the input module.

FIG. 6 shows selection of a target ball in the second embodiment of the present disclosure. The user can select a target ball 22 to be struck according to preference. As shown in FIG. 6, when the user selects the target ball 22a, the calculus module 3022 calculates the striking path (such as the best striking path) of the target ball 22a, and displays the information of the striking path of the target ball 22a, to give the user a striking suggestion. Specifically, the display module 303 may be a touch display module. The user can select a certain billiard ball as the target ball 22 on the desktop image by clicking (such as clicking or double clicking), circle drawing, and the like.

In step S204, displaying the calculation result on a portable electronic device for user to refer.

Specifically, the calculation results may include the striking path, the striking angel, the striking strength, the striking position, the striking manner, and the striking speed. The calculation results may also include the movement path and the stop position of the cue ball after striking the target ball. Therefore, the striking suggestion provided by the display module includes the striking path, the striking angel, the striking strength, the striking position, the striking manner, and the striking speed. The striking suggestion also includes the movement path and the stop position of the cue ball after striking the target ball.

The striking path in the calculation results is preferably superimposed on the image information (such as the first image) acquired by the image acquisition module 301, and then transmitted to the display module 303 for display. The striking path also may be superimposed on the second image including the virtual model for display. Additionally, the striking angle, the striking strength, the striking position, the striking manner, and the striking speed are able to be displayed on the second image, or able to be played through the voice module 304.

The virtual cue stick building module 307 is configured to create a virtual cue stick image with the same width as the physical cue stick, and the virtual cue stick image is located on the striking path. Therefore, the user can easily strike the billiard ball with reference to the angle and width of the cue in the virtual cue stick image.

Referring to FIG. 7, the position and manner of placing a virtual cue stick in the second embodiment is shown. The portable electronic device carrying the display module 303 is placed on the billiard table. The length and width of the display module 303 of the portable electronic device may be respectively parallel to the length and width of the billiard table. The user can strike the billiard ball with reference to the angle and width of the cue in the virtual cue stick image. Specifically, the user can place the portable electronic device along the edge of the billiard table. The virtual cue stick image may be a partial cue image, and the width of the partial cue image is consistent with the projected width of the physical cue stick. Since the projected width of the physical cue stick (the diameter thereof) is gradually increased from the head (hitting end) to the tail, the width of the virtual cue stick image displayed on the display module 303 is also gradually increased from the head to the tail. Therefore, it is convenient for the user to align the physical cue stick with the virtual cue stick image. In addition, the user can adjust the position of the cue displayed in the virtual cue stick image through the input module. For example, the virtual cue stick image originally displaying the middle part of the virtual cue stick can be adjusted to display the front or the rear part of the virtual cue stick by the user according to actual needs. Specifically, when the input module is a touch screen disposed on the display module, the user can slide the virtual cue stick image displayed on the screen to adjust the display position of the virtual cue stick. Therefore, it is convenient to align the physical cue stick with the virtual cue stick.

In one embodiment, the user can place the portable electronic device carrying the display module 303 on the extension line of the striking path of the target ball, the portable electronic device being adjacent to the cue ball. As shown in FIG. 7, the portable electronic device is placed at position A or position C (preferably placed at the position A of the billiard table edge). At this time, the virtual cue stick image displayed by the display module 303 includes only a part of the virtual cue stick. When the user places the physical cue stick corresponding to the width and angle of the virtual cue stick in the image, the direction or positioning angle of the physical cue stick in the user's hand is the best striking direction (also called the best striking angle). Therefore, the success rate of the user's striking can be improved.

In another embodiment, if there is another billiard ball at the position A or the position C, the portable electronic device having the display module 303 may be placed at position B or position D. It is required to ensure that length and width of the billiard table displayed by the display module 303 can be respectively parallel to the length and width of the physical billiard table. At this time, the user can adjust the direction of the physical cue stick according to the virtual cue stick image on the portable electronic device, and then align the physical cue stick in the position corresponding to the cue ball.

Alternatively, in another embodiment, the ball-striking assist system 30 further includes a judging module 308. The judging module 308 is configured to obtain an actual placement direction (or an actual angle or an actual placement angle) of the physical cue stick 3 in the user's hand, and compare the actual placement direction with the direction of the striking path calculated by the calculation module, to determine whether the actual placement direction of the physical cue stick 3 in the user's hand is correct, and to provide the judgment result to the user. Specifically, the judging module 308 may obtain a picture or video of the actual placement direction of the physical cue stick 3, and analyze the actual placement direction of the physical cue stick 3 according to the picture or video. The picture or video of the actual placement direction of the physical cue stick 3 can be obtained through the image acquisition module 301, and the image acquisition module 301 can be a front camera of the portable electronic device. During application, as shown in FIG. 4, the portable electronic device can be placed at the position A or position B, so that the image acquisition module 301 can obtain the picture of the physical cue stick 3, and the picture is analyzed to get the actual placement direction of the physical cue stick 3.

Specifically, when the actual placement direction of the physical cue stick 3 in the user's hand is substantially the same as the direction of the striking path, the difference between the two being within a predetermined range, the judging module 308 controls the display module 303 to display “the actual placement direction of the physical billiard 3 is correct” to the user. Obviously, the judging module 308 also can control the voice module 304 to say “the actual placement direction of the physical billiard 3 is correct” to the user. When the actual placement direction of the physical cue stick 3 in the user's hand is different from the direction of the striking path, the difference between the two being over the predetermined range, the judging module 308 controls the display module 303 to display “the actual placement direction of the physical billiard 3 is incorrect” to the user. Obviously, the judging module 308 controls the voice module 304 to warn “the actual placement direction of the physical billiard 3 is incorrect” to the user. Furthermore, when the actual placement direction of the physical billiard 3 is incorrect, the judging module may provide an adjustment suggestion according to the judgment result.

Compared with the first embodiment, the ball-striking assist system of the second embodiment further includes the input module 306, the virtual cue stick building module 307, and the judging module 308. The input module 306 can let the user choose the target ball by himself. The virtual cue stick building module 307 can let the display module 303 display the virtual cue stick image, and the user can place the physical cue stick according to the virtual cue stick image. The judging module 308 is configured to judge whether the physical cue stick is placed in correct direction. Therefore, the user experience is improved, and the success rate and level of striking are improved.

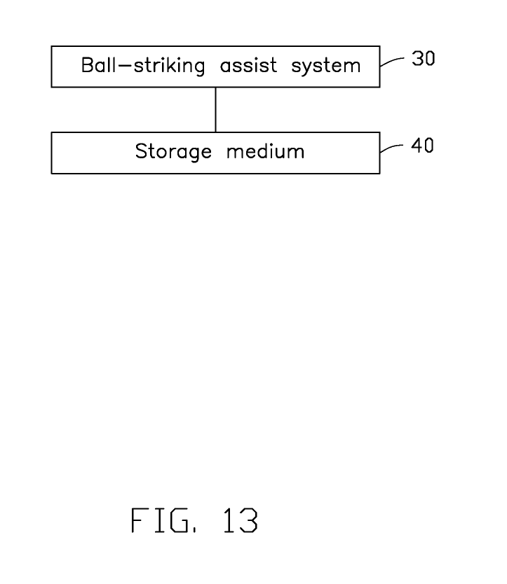

Referring to FIG. 13, the ball-striking assist system 30 further includes a storage medium 50. The storage medium 50 stores at least one software programs in the form of computerized codes that are executed by the ball-striking assist system 30. The at least one software programs includes steps of the ball-striking assist method described above.

It is to be understood, even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. A ball-striking assist method, wherein the ball-striking assist method comprising:
obtaining pictures or videos of a billiard table, the billiard table comprises billiard balls, and the billiard balls comprises a cue ball and at least one target ball;
analyzing positions of the cue ball and the at least one target ball in the pictures or videos;
calculating a striking path of the at least one target ball according to the positions; and
providing a striking suggestion according to the striking path, the striking suggestion comprises at least the striking path, the striking suggestion is provided to a user through a portable electronic device.

2. The ball-striking assist method of claim 1, wherein the ball-striking assist method is implemented by a software installed in a portable electronic device, the portable electronic device comprises one of a smart phone, a flat computer, and a smart wearable device.

3. The ball-striking assist method of claim 2, wherein the portable electronic device is an augmented reality device comprising:
a camera, configured to acquire pictures or videos of the billiard table; and
a processor, configured to analyze position of at least one billiard ball in the pictures or videos, calculate the striking path of the at least one billiard ball according the position, and provide the striking suggestion according to the striking path, the striking suggestion is provided to the user through manners of voice or display or combining voice and display.

4. The ball-striking assist method of claim 3, wherein the augmented reality device further comprises a display device, the striking suggestion comprises a striking path, the display device displays the striking path, and the striking path is superimposed or displayed in an augmented reality manner on the billiard table that the user sees through the augmented reality device.

5. The ball-striking assist method of claim 4, wherein the method further comprises:
detecting a striking motion of the user and predicting an actual striking path;
comparing the actual striking path with the calculated striking path; and
providing comparing results to the user;
the display device displays the calculated striking path and the actual striking path, wherein the calculated striking path and the actual striking path are superimposed or displayed in the augmented reality manner on the billiard table that the user sees through the augmented reality device.

6. The ball-striking assist method of claim 1, wherein the method further comprises:
receiving input information from the user, wherein the input information comprises a selected target ball; and
a striking path corresponding to the selected target ball.

7. The ball-striking assist method of claim 1, wherein the method further comprises:
creating a virtual cue stick image with the same width as a physical cue stick, the virtual cue stick image is configured to guide the user to place the physical cue stick referring to the virtual cue stick.

8. The ball-striking assist method of claim 1, wherein the method further comprises:
detecting a placement direction of the physical cue stick in real time;
comparing the placement direction of the physical cue stick with a direction of the virtual cue stick or a direction of the striking path;
providing comparing results to the user.

9. The ball-striking assist method of claim 1, wherein the striking path includes movement path of the cue ball and the at least one target ball, the method further comprises:
displaying a movement path and a stop position of the cue ball after striking the target ball.

10. The ball-striking assist method of claim 1, wherein the method further comprises:
calculating a striking angle, a striking strength, a striking position, a striking manner, and a striking speed, the striking strength is displayed in a graphical or numerical manner.

11. A ball-striking assist system, comprising:
an image acquisition module;
an analysis module;
a calculus module;
a display module; and
a storage medium storing at least one software programs in the form of computerized codes that are executed by the ball-striking assist system, the at least one software programs comprising instructions for:
acquiring, at the image acquisition module, pictures or videos of a billiard table, wherein the pictures or videos display positions of at least two billiard balls on the billiard table, the at least two billiard balls comprises a cue ball and at least one target ball;
analyzing, at the analysis module, positions of the at least two billiard balls;
calculating, at the calculus module, a striking path of the at least two billiard balls according to the positions;
displaying, at the display module, a striking suggestion according to calculation results of the striking path, wherein the striking suggestion comprises at least the striking path.

12. A portable electronic device, the portable electronic device is one of a smart phone, a flat computer, and a smart wearable device, wherein the portable electronic device comprising:
a ball-striking assist system; and;
a storage medium storing at least one software programs in the form of computerized codes that are executed by the ball-striking assist system, the at least one software programs comprising instructions for:
acquiring pictures or videos of a billiard table, wherein the pictures or videos display positions of at least two billiard balls on the billiard table, the at least two billiard balls comprises a cue ball and at least one target ball;
analyzing positions of the at least two billiard balls;
calculating a striking path of the at least two billiard balls according to the positions;
displaying a striking suggestion according to calculation results of the striking path, wherein the striking suggestion comprises at least the striking path.
